(19) United States
(12) Patent Application Publication
(10) Pub. No.: US 2018/0093192 A1
(43) Pub. Date: Apr. 5, 2018

(54) PLAYING CARD WITH MOVEMENT INSTRUCTION, APPARATUS AND METHOD

(71) Applicant: PlayFusion Limited, Cambidge (GB)

(72) Inventors: Riaan HODGSON, Hannington, Northants (UK); David GOMBERG, New York, NY (US); Mark GERHARD, Waresley (UK); Chris LONG, Cambridge (UK); Benny PECKZEK, Cambridge (UK)

(21) Appl. No.: 15/718,851

(22) Filed: Sep. 28, 2017

Related U.S. Application Data
(60) Provisional application No. 62/404,472, filed on Oct. 5, 2016.

(51) Int. Cl. A63F 13/822; A63F 1/00

(52) U.S. Cl. CPC A63F 13/822; A63F 2001/008; A63F 1/00

(57) ABSTRACT

A playing card includes a substrate having a first face, a second face opposite the first face, and at least three sides. The first face has at least one icon configured to instruct a user to move the substrate to one of at least three orientations. Each orientation of the at least three orientations has an effect in the context of a game with which the playing card is associated.

### PRIORITY

The present application claims priority to U.S. Provisional Patent Application No. 62/404,472, filed Oct. 5, 2016, which is incorporated by reference herein in its entirety.

### BACKGROUND

Some card games include a deck of playing cards. Some playing cards included in the deck of playing cards include instructions for a user to tap a playing card. Some playing cards may instruct a user to move the playing card into one of two states. For example, some playing cards may instruct a user to orient the playing card right side up or right side down. Some playing cards may alternatively instruct a user to orient the playing card face up or face down. Instructions to tap or orient a playing card in a certain manner are often referred to as mechanics.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a front-side view of a playing card, in accordance with one or more embodiments.

FIG. 2 is back-side view of a playing card, in accordance with one or more embodiments.

FIG. 3 is a flowchart of a series of turns played out by a user of a playing card in the context of a game with which the playing card is associated, in accordance with one or more embodiments.

FIG. 4 is a flowchart of a method of using a playing card in the context of a game with which the playing card is associated, in accordance with one or more embodiments.

FIG. 5 is a functional block diagram of a computer or processor-based system upon which or by which an embodiment is implemented.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the playing card or apparatus discussed herein in addition to the orientation depicted in the figures. The playing card or apparatus discussed herein may be otherwise oriented (rotated 90 degrees or at other orientations) and the spatially relative descriptors used herein may likewise be interpreted accordingly. Similarly, other relative terms, such as “first,” “second,” “third,” and the like, may be used herein for ease of description to describe one element or feature's relationship to another element(s) or feature(s) as illustrated in the figures. In some embodiments, relative terms, such as “first,” “second,” “third,” and the like, are not intended to imply a particular order. Such terms are instead intended to encompass different orientations of the playing card or apparatus in use or operation in addition to the orientations depicted in the figures. In some embodiments, relative terms, such as “first,” “second,” “third,” and the like, imply an order of the different orientations of the playing card or apparatus discussed herein.

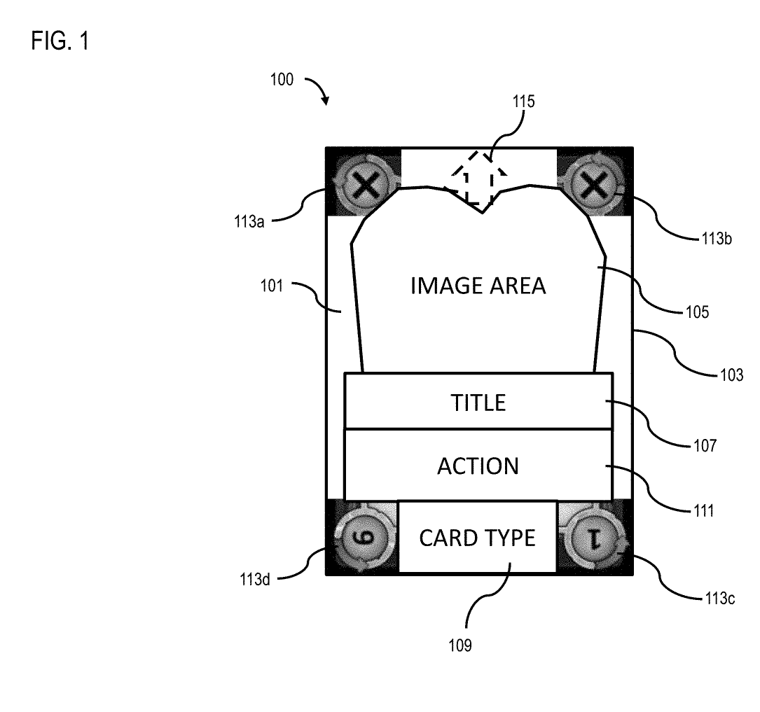

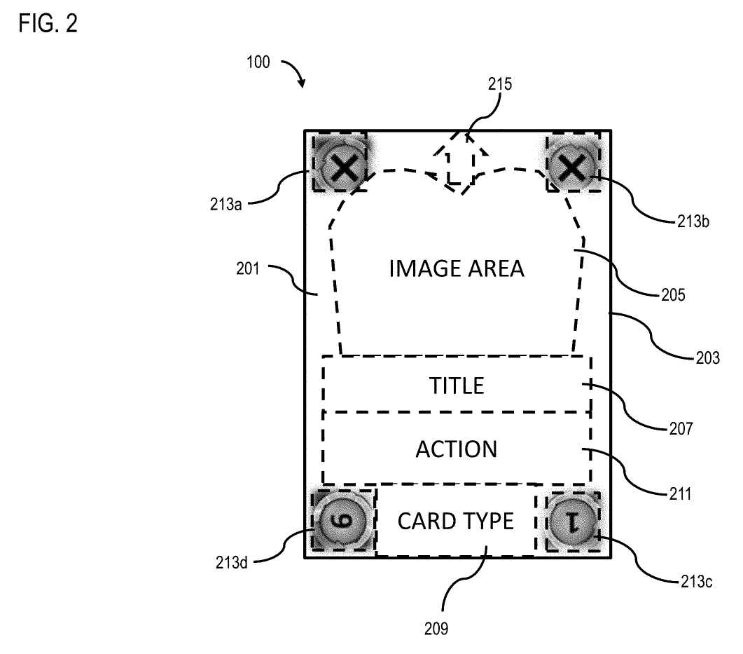

FIG. 1 is a front-side view of a playing card 100, in accordance with one or more embodiments. Playing card 100 is usable in the context of a game. Playing card 100 comprises a first face 101, a second face (FIG. 2) opposite the first face 101, and at least three sides 103. The first face 101 has an image area 105, a title area 107, a card type area 109, an action area 111, and icons 113a-113d (collectively referred to as “icon(s) 113”). The playing card 100 has at least one default orientation. In some embodiments, one or more of the icons 113 are configured to instruct a user to move the playing card 100 to one of at least two orientations. In some embodiments, the at least two orientations are inclusive of the default orientation. In some embodiments, the at least two orientations are exclusive of the default orientation. In some embodiments, one or more of the icons 113 are configured to instruct a user to move the playing card 100 to one of at least three orientations. In some embodiments, the at least three orientations are inclusive of the default orientation. In some embodiments, the at least three orientations are exclusive of the default orientation. In some embodiments, each orientation of the playing card 100 has an effect in the context of the game with which the playing card 100 is associated. In some embodiments, each orientation of the at least two orientations has an effect in the context of the game with which the playing card 100 is associated. In some embodiments, each orientation of the at least three orientations has an effect in the context of the game with which the playing card 100 is associated. In some embodiments, a playing card 100 free from having more than a default orientation is free from having an effect in the context of the game with which the playing card 100 is associated.

In some embodiments, playing card 100 comprises a substrate having the at least three sides 103. In some embodiments, the substrate has at least four sides 103. In some embodiments, the substrate has at least six sides 103. In some embodiments, the substrate has at least eight sides 103. In some embodiments, the substrate is circular, oval, or otherwise curved such that the substrate has one or two sides 103.

In some embodiments, the playing card 100 comprises an equal quantity of sides 103 as the substrate. In some embodiments, the playing card 100 comprises a greater quantity of sides 103 than sides of the substrate. For example, if the substrate has four sides, the playing card optionally has eight sides 103, defined by a border on the substrate. In some embodiments, the playing card 100 comprises a lesser quantity of sides than sides of the substrate. For example, if the substrate has four sides, the playing card optionally has three sides 103, defined by a border on the substrate.

The substrate comprises paper, plastic, glass, ceramic, vinyl, wood, metal, or some other suitable material.

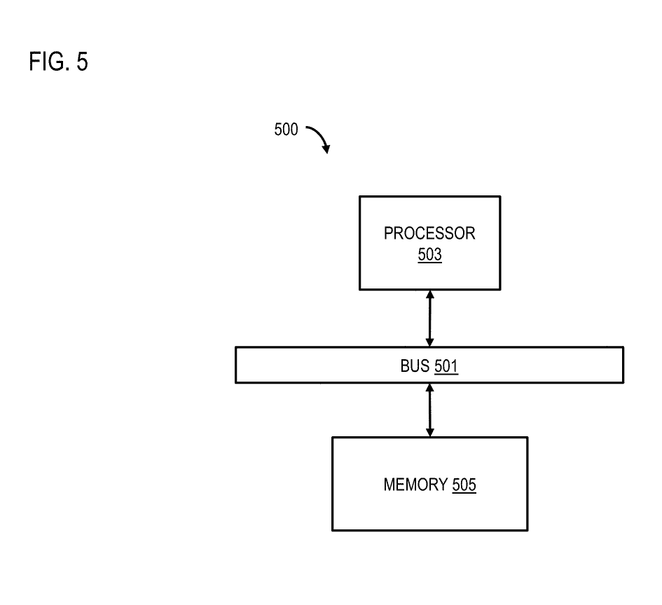

In some embodiments, the playing card 100 viewable by way of a display. In some embodiments, a computer system or mobile device comprising or communicatively coupled to a computer or processor-based system such as system 500 (FIG. 5) is configured to cause the playing card 100 is be viewable by way of a display associated with a computer, mobile device, having connectivity to the computer system or mobile device, or a combination thereof.

In some embodiments, a quantity of icons 113 is equal to a quantity of sides 103 of the playing card 100 or the substrate. In some embodiments, a quantity of icons 113 is greater than a quantity of sides 103 of the playing card 100 or the substrate. In some embodiments, a quantity of icons 113 is less than a quantity of sides 103 of the playing card 100 or the substrate.

The icons 113 are located in corner regions of the playing card 100 near where the sides 103 meet. In some embodiments, a quantity of icons 113 is equal to a quantity of corner regions. In some embodiments, a quantity of icons 113 is greater than a quantity of corner regions. In some embodiments, a quantity of icons 113 is less than a quantity of corner regions.

In some embodiments, one or more of the icons 113 is located nearer to a center region of the playing card 100 than to one of the sides 103. In some embodiments, one or more of the icons 113 is adjacent to one of more of the sides 103 such that the one or more icons 113 is located nearer to one or more of the sides 103 than to the center region of the playing card 100.

The icons 113 are configured to instruct a user to move the playing card 100 from a first orientation to a second orientation based on one or more of a position of the icon 113, a time in the context of the game, or a combination thereof. For example, in the context of the game, if the playing card 100 is put into play such that icon 113a is in the upper left-hand corner of the playing card 100, icon 113a instructs the user to rotate the playing card 100 in a counter-clockwise direction until icon 113b is in the upper left-hand corner from the user's perspective. Icon 113a is in an active position of the playing card 100. The active position is the position of the icon 113 that is applicable at a given time or player turn in the context of the game. Though icons 113 are configured to instruct a user to rotate the playing card 100 in a counter-clockwise direction, some embodiments optionally include one or more icons 113 configured to instruct a user to rotate the playing card 100 in a clockwise direction.

In some embodiments, one or more of the icons 113 is configured to instruct the user to flip the playing card 100 to an orientation that exposes the second face of the playing card 100. In some embodiments, the icon 113 configured to instruct the user to flip the playing card 100 instructs the user to completely flip the playing card 100 such that the first face 101 is hidden from view. In some embodiments, the icon 113 configured to instruct the user to flip the playing card 100 instructs the user to partially flip the playing card 100 such that the first face 101 and the second face of the playing card 100 are viewable by the user.

In some embodiments, one or more of the icons 113 is configured to instruct the user to move the playing card 100 to an orientation based on an event in the context of the game. For example, in the context of the game, if the playing card 100 is put into play such that icon 113a is in the upper left-hand corner of the playing card 100, icon 113a optionally instructs the user to rotate the playing card 100 in a counter-clockwise direction until icon 113b is in the upper left-hand corner from the user's perspective based on a different playing card being put into play, or being moved from one orientation to a different orientation, or some other suitable event in the context of the game.

In some embodiments, one or more of the icons 113 is configured to cause an effect or action to occur in the context of the game. In some embodiments, the action area 111 is configured to provide details about an action to occur in the context of the game, and the icons 113 are configured to indicate when and for how long the effect or action instructed by the action area 111 is to occur. In some embodiments, the icons 113 are configured to instruct how much or how strong the effect or action instructed by the action area 111 is. In some embodiments, the action area 111 is configured to provide details regarding one or more of an increase in health, a decrease in health, an increase in power, a decrease in power, a character capability, a character use of a weapon, a character use of an article, or other suitable effect or action associated with a user or character of the user that puts the playing card 100 into play or associated with a different user or character of the different user participating in the game.

In some embodiments, one or more of the icons 113, the action area 111 or the card type 109 is configured to instruct the user to place the playing card 100 in a particular orientation if the playing card 100 is removed from play and then replaced into a game play area. For example, if the playing card 100 is in play, in one of at least three orientations at a given time, and the playing card 100 is removed from the game play area, one or more of the icons 113, the action area 111 or the card type 109 is configured to instruct the user to place the playing card 100 in a default orientation different from the particular orientation the playing card 100 was in at the time of removal from the game play area such as having icon 113a in the upper left-hand corner.

In some embodiments, if the playing card 100 is in play, in one of at least three orientations at a given time, and the playing card 100 is removed from the game play area, one or more of the icons 113, the action area 111 or the card type 109 is configured to instruct the user to place the playing card 100 in the particular orientation the playing card 100 was in at the time of removal from the game play area. In some embodiments, if the playing card 100 is in play, in one of at least three orientations at a given time, and the playing card 100 is removed from the game play area, one or more of the icons 113, the action area 111 or the card type 109 is configured to instruct the user to place the playing card 100 in the particular orientation the playing card 100 was in at the time of removal from the game play area based on an event in the context of the game.

In some embodiments, if the playing card 100 is in play, in one of at least three orientations at a given time, and the playing card 100 is removed from the game play area, one or more of the icons 113, the action area 111 or the card type 109 is configured to instruct the user to place the playing card 100 in an orientation that is different from the particular orientation the playing card 100 was in at the time of removal from the game play area, based on the particular orientation of the playing card 100 at the time of removal. In some embodiments, if the playing card 100 is in play, in one of at least three orientations at a given time, and the playing card 100 is removed from the game play area, one or more of the icons 113, the action area 111 or the card type 109 is configured to instruct the user to place the playing card 100 in an orientation that is different from the particular orientation the playing card 100 was in at the time of removal from the game play area, based on an event in the context of the game.

In some embodiments, the one or more of the icons 113, the action area 111 or the card type area 109 are configured to instruct a user to one or more of extend play of the playing card 100, control the movement of the playing card 100, control the rotation of the playing card 100, rewind a rotation of the playing card 100, fast forward or skip to a movement or rotation of the playing card 100, reset the orientation of the playing card 100 to the default orientation or some other predetermined orientation, pause the movement of the playing card 100 or rotation of the playing card 100, or other suitable operation.

In some embodiments, the playing card 100 comprises a pointer icon 115 located on the first face 101 such that the movement of the playing card 100 to a particular orientation causes the pointer icon 115 to be directed toward a target in the context of the game. The target is independent from the playing card 100. For example, in the context of the game, as a user moves the playing card 100 to different orientations, the pointer icon 115 points in different directions. In some embodiments, one or more of the action area 111 or the card type 109 is configured to instruct an effect or action to occur in the context of the game to some other user or character associated with the other user. In some embodiments, the pointer icon 115 is configured to instruct the user to cause the action to occur with respect to the other user, the character associated with the other user, a character in the context of the game, a weapon in the context of the game, or some other suitable action, based on the direction the pointer icon 115 points at a time which the pointer icon 115 points toward a target, or when the pointer icon 115 is active.

For example, if the playing card 100 is in an orientation that the pointer icon does not point toward a target, the pointer icon 115 is not active. But, as the orientation of the playing card changes throughout the course of the game, the pointer icon 115 is caused to change direction, thereby being activated if the pointer icon 115 is in an active position in the context of the game. In some embodiments, the active position is any orientation in which the pointer icon 115 is directed toward a target, directed toward the user, directed away from the user, directed toward a different user, directed toward a different playing card, or some other suitable direction. In some embodiments, the action area 111 of the playing card is configured to instruct the user to remove the playing card from play upon the pointer icon 115 being directed toward the target. For example, if the target is another user or character, and the pointer icon 115 eventually points to the target after being played and the playing card is moved to one or more orientations, then the action area 111 is configured to instruct the user that the playing card 100 has expired upon use. In some embodiments, if the action area indicates that the playing card 100 is a weapon or attack card that has a one-shot missile firing capability, then once the playing card 100 reaches the target after one or more turns, then the playing card 100 is configured to expire after use in the context of the game. In some embodiments, if the target is the user, the action area 111 is configured to instruct the user that the playing card 100 has expired upon use—i.e. after the pointer icon 115 is directed toward the user.

In some embodiments, the image area 105 is configured to include a graphic that corresponds to the title of the playing card 100 that is included in the title area 107. In some embodiments, the card type indicated in the card type area 109 is a buff card, a passive card, an action card, a hero card, a character card, a weapon card, health card, a defense card, location card, a vehicle card, an equipment card, or some other suitable type of card.

In some embodiments, the action area 111 is configured to instruct the user to cause an effect in the context of the game that has a duration based on one or more of the icons 113. In some embodiments, the first face 101 includes icons 113 that have empty fields, which make the icons 113 configured to indicate that the effect has a duration for as long as the playing card stays in play. In some embodiments, the icons 113 are configured to instruct the user that the effect instructed by the action area 111 of the playing card 100 is to stay in play indefinitely. In some embodiments, the one of more of the icons 113 has a rotating arrow symbol. An icon 113 having a rotating arrow symbol is configured to instruct the user to rotate the playing card 100 by 90 degrees at the start of the user's turn. In some embodiments, the one or more of the icons 113 has an irregular shape. An icon 113 having an irregular shape is configured to instruct the user to rotate the playing card 100 by 90 degrees based on an occurrence of an event in the context of the game or an effect of the playing card 100 being triggered by some other event in the context of the game, orientation of the playing card, another playing card being put into play, a combination of playing cards being achieved, or some other suitable occurrence. In some embodiments, the playing card 100 comprises icons 113 that instruct different types of movements based on one or more different types of events in the context of the game. For example, if a playing card 100 is put into play that has an icon 113 having a rotating arrow symbol in the active position and a different icon 113 having an irregular shape in a different position, the playing card 100 is rotated at the start of a player's turn based on the first icon 113 having the rotating arrow symbol, the icon 113 having the irregular shape is moved to the active position based on the rotation, and then the playing card 100 remains in the orientation in which the icon 113 having the irregular shape in the active position until a suitable event in the game occurs. In some embodiments, an icon 113 having a rotating arrow symbol or other suitable symbol is configured to instruct a user to move the playing card 100 from one orientation to another automatically based on a player turn and an icon 113 having an irregular shape is configured to instruct the user to pause the playing card 100 in the context of the game until a predetermined quantity of player turns passes or an event in the context of the game occurs. In some embodiments, the pausing of the playing card 100 delays the action or effect of the playing card 100 from occurring. In some embodiments, the pausing of the playing card 100 extends the action or effect of the playing card 100. In some embodiments, the playing card 100 includes an icon 113 that instructs one movement based on one type of event in the context of the game, and another icon 113 that instructs another movement based on a different type of event in the context of the game. The different icons 113, in some embodiments, are in series. In some embodiments, the different icons 113 are separated by an icon 113 configured to instruct the user to move the playing card 100 based on a player turn in the context of the game.

In some embodiments, one or more of the icons 113 includes an “X,” a blank, or some other symbol. An icon 113 having an “X,” a cross, a blank, or some other symbol is configured to instruct the user to ignore the effect or action instructed by the action area 111 during a turn in which the playing card 100 is oriented such that the icon 113 having the “X,” blank, other symbol is in the active position. In some embodiments, one or more of the icons 113 includes a numerical value, a quantity of dots, a quantity of slashes, some other counting format, a symbol corresponding to the action instructed by the action area 111, a blank, or some other suitable symbol. An icon 113 having a numerical value, a quantity of dots, a quantity of slashes, some other counting format, a symbol corresponding to the action instructed by the action area 111, a blank, or some other suitable symbol is configured to instruct the user to cause the effect or action instructed by the action area 111 to occur during a turn in which the playing card 100 is oriented such that the icon 113 having the numerical value, quantity of dots, quantity of slashes, other counting format, symbol corresponding to the action instructed by the action area 111, blank, or other suitable symbol is in the active position. In some embodiments, if the icon 113 in the active position is free from including an “X,” a blank or other symbol, then the icon 113 is configured to instruct the user to cause the effect or action instructed by the action area 111 to occur immediately in the context of the game.

In some embodiments, the active position is predetermined. Icons 113 move into and out of the active position as the playing card 100 is moved or rotated from one orientation to another in accordance with the passage of turns or time, or the occurrence of events in the context of the game. In some embodiments, the active position is the top left hand corner of the playing card 100. In some embodiments, the active position is a different corner of the playing card 100. In some embodiments, the active position is predetermined based on a quantity of sides and/or positions of the icons 113. For example, if the playing card 100 is a six-sided playing card and the icons 113 are along the sides 103 of the playing card 100, then active position is predetermined to be along one of the sides 103 or in a corner region where two of the sides 103 meet and an icon 113 is located.

In some embodiments, the playing card 100 is one of a plurality of playing cards 100 that together make up a deck of playing cards 100. The deck of playing cards 100 includes at least two different types of playing cards 100, wherein a first playing card 100 included in the deck of playing cards 100 has at least one orientation, and a second playing card 100 included in the deck or playing cards 100 has at least two orientations. In some embodiments, the deck of playing cards 100 includes at least two different types of playing cards 100, wherein a first playing card 100 included in the deck of playing cards 100 has at least one orientation, and a second playing card 100 included in the deck of playing cards 100 has at least three orientations. In some embodiments, the deck of playing cards 100 includes at least two different types of playing cards 100, wherein a first playing card 100 included in the deck of playing cards 100 has at least two orientations, and a second playing card 100 included in the deck of playing cards 100 has at least three orientations. In some embodiments, the deck of playing cards 100 includes at least three different types of playing cards 100, wherein a first playing card 100 included in the deck of playing cards 100 has at least one orientation, a second playing card 100 included in the deck of playing cards 100 has at least two orientations, and a third playing card 100 included in the deck of playing cards 100 has at least three orientations. In some embodiments, one or more of the playing cards 100 included in the deck of playing cards has a different quantity of sides than the other playing cards 100 included in the deck of playing cards. In some embodiments, all of the playing cards 100 included in the deck of playing cards have an equal quantity of sides.

FIG. 2 is back-side view of the playing card 100, in accordance with one or more embodiments. The back-side view of playing card 100 includes second face 201 opposite the first face 101 (FIG. 1). The second face 201 includes features similar to those discussed with respect to first face 101, with the reference numerals increased by 100. The backside view of playing card 100 includes at least three sides 203. The second face 201 optionally has one or more of an image area 205, a title area 207, a card type area 209, an action area 211, and icons 213a-213d (collectively referred to as “icon(s) 213”). Icons 213 are configured to instruct a user to move the playing card 100 to one of at least three orientations. Each orientation of the at least three orientations has an effect in the context of the game with which the playing card 100 is associated.

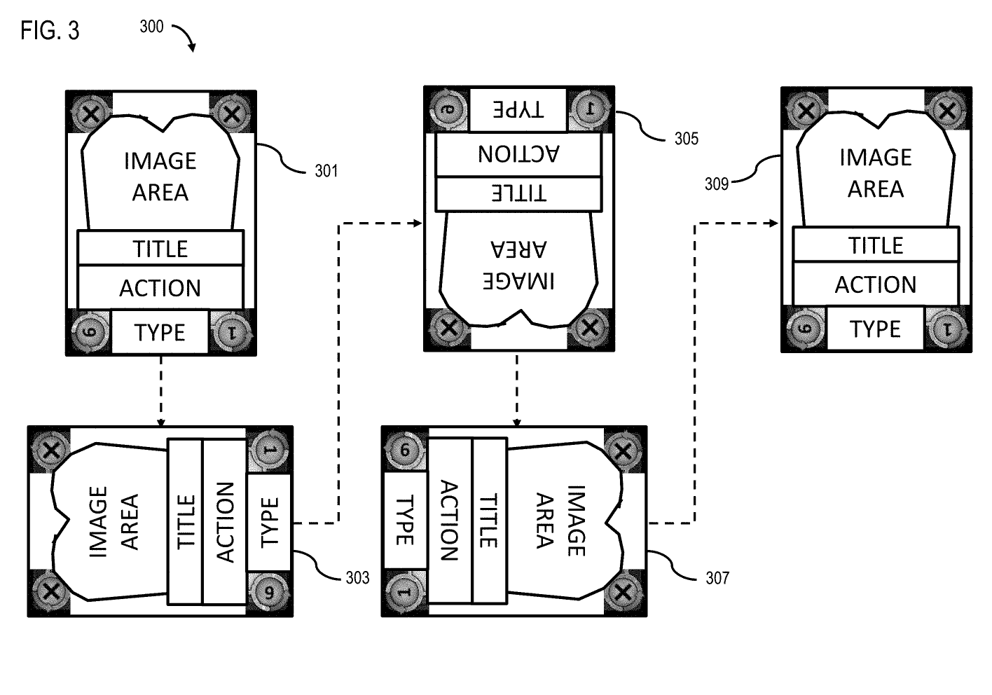

FIG. 3 is a flowchart 300 of a series of turns played out by a user of a playing card such as playing card 100 (FIG. 1) in the context of the game, in accordance with one or more embodiments.

The icons 113 (FIG. 1) on the playing card 100 are a way of displaying and delaying card effects in the context of the game. An icon 113 is present or active for a player turn in the context of the game, beginning with a turn in which the card was played.

In some embodiments, icons 113 have movement instructions, values, purposes, some other suitable indicator, or a combination thereof. In some embodiments, a value of an icon 113 in the top left-hand corner of the playing card 100 in its current orientation determines what is happening with the card on a particular turn. In some embodiments, an icon 113 includes one or more arrows that instruct a user to rotate the playing card 100 in an instructed direction (e.g., clockwise, counter-clockwise, one rotation, two or more rotations, or some other suitable rotation amount or direction) in a given turn. In some embodiments, icons 113 are free from including directional arrows, but the action area 111 (FIG. 1) is configured to instruct the user to rotate the playing card 100 based on an event in the context of the game such as a player turn, a different playing card being played by the user or another user, or some other combination of events in the context of the game. After the rotation has been completed, the icon 113 that ends up in the top left hand corner of the playing card 100 in the new orientation is the active icon 113 and a gameplay effect of the playing card 100 in the given turn is governed by one or more of the icon 113, the action area 111, the card type area 109 (FIG. 1), the orientation of the playing card 100, a direction the target icon 115 (FIG. 1) is pointing, or a combination thereof.

In step 301, the playing card is played by putting the playing card 100 into a game play area. The playing card 100 is put into play by one or more of placing the playing card 100 in a starting orientation. In some embodiments, the starting orientation is a default orientation of the playing card 100. In some embodiments, the default orientation of the playing card 100 is with the first face 101 (FIG. 1) facing up, with the second face 201 (FIG. 2) facing down, and with the title area 107 (FIG. 1) being in an upright orientation. Upon putting the playing card 100 into play, an effect of action of the playing card 100 occurs before the end of the user's turn. To find out this effect or action, the user consults the icon 113 in the active position. In this example, the top-left corner of the playing card 100 is the active position. In this orientation, the icon 113 in the top left hand corner of the playing card 100 shows an “X” and a counter-clockwise arrow. In this example, the icon 113 instructs the user that no effect or action takes place and the user should ignore the instructions in the action area so that no effect occurs for this turn.

In step 303, the playing card 100 is rotated one turn to the left, because the icon 113 in the upper left hand corner in step 301 instructed the user to rotate the playing card 100 counter-clockwise. Upon completion of the rotation, the user consults the icon 113 in the top left hand corner. In this second orientation, the icon 113 in the active position continues to show an “X” and a counter-clockwise arrow. In this example, the icon 113 again instructs the user that no effect or action takes place and the user should ignore the instructions in the action area 111 so that no effect or action occurs for this turn.

In step 305, the playing card 100 is rotated one turn to the left, because the icon 113 in the upper left hand corner in step 303 instructed the user to rotate the playing card 100 counter-clockwise. Upon completion of the rotation, the user consults the icon 113 in the top left hand corner. In this third orientation, the icon 113 in the active position shows a “1” and a counter-clockwise arrow. Because the icon 113 in the active position does not have an X in it, the instructions in the action area 111 or the icon 113 in the active position take effect. For example, if the action area 111 of the playing card instructs the user to “deal [rotation] damage to your target,” the [rotation] icon in the description instructs the user to get the value for the amount of damage to be dealt based on the value in the icon 113 that is in the active position. In this example, this results in the playing card 100 instructing the user to deal damage having a value of “1” to the target on this turn.

In step 307, the playing card 100 is rotated one turn to the left, because the icon in the upper left hand corner in step 305 instructed the user to rotate the playing card 100 counter-clockwise. Upon completion of the rotation, the user consults the icon 113 in the top left hand corner. In this third orientation, the icon 113 in the active position shows a “6” and a counter-clockwise arrow. Because the icon 113 in the active position does not have an X in it, the instructions in the action area 111 or the icon 113 in the active position take effect. For example, if the action area 111 of the playing card 100 instructs the user to “deal [rotation] damage to your target,” the [rotation] icon in the description instructs the user to get the value for the amount of damage to be dealt based on the value in the icon 113 that is in the active position. In this example, this results in the playing card 100 instructing the user to deal damage having a value of “6” to the target on this turn.

In step 309, the playing card 100 is rotated one turn to the left, because the icon 113 in the upper left hand corner in step 307 instructed the user to rotate the playing card 100 counter-clockwise. In some embodiments, the playing card 100 is defined as being in play until the playing card 100 has been rotated or moved to the starting orientation. In some embodiments, an icon 113 in the active position is configured to instruct a time in the context of the game at which the playing card 100 is expired. For example, if the result of a rotation does not show a rotation icon 113 in the active position on the playing card 100, then the playing card 100 is instructed to expire at that turn. In this example, as a result of the playing card 100 reaching the starting orientation on the user's fifth turn, the playing card 100 expires in the context of the game. In some embodiments, the playing card 100 expires in the context of the game if the playing card 100 is free from having an icon 113 in the active position upon being put into play or following one or more movements of the playing card 100 from one orientation to another orientation. For example, if the playing card 100 has two rotation icons 113, the playing card 100 is rotated one turn to the left after one player turn based a first rotation icon 113 being in the active position, the playing card 100 then has a second rotation icon 113 in the active position, the playing card 100 is then rotated one turn to the left after another player turn based on the second rotation icon 113 being in the active position, and the playing card 100 following the second turn to the left is free from having an icon 113 in the active position, upon which the playing card 100 expires in the context of the game. In some embodiments, the expiration of the playing card 100 results in the playing card 100 being removed from the game play area. In some embodiments, the cycle continues.

In some embodiments, the playing card 100 is configured to track the passage of time based on an orientation of the playing card 100. For example, if the playing card 100 has four orientations such as the example playing card 100 shown in flowchart 300, then a player turn or a period time in the context of the game is associated with the orientation of the playing card 100, and the playing card 100 is configured to indicate up to five different periods of time based on the orientation and the order by which the orientations change. In some embodiments, the playing card 100 is has an icon configured to instruct the user to flip the playing card 100 so as to expose the second face 201 (FIG. 2) of the playing card 100. Such an instruction icon increases a quantity of potential orientations, thereby increasing an amount of time that may be tracked in the context of the game. For example, if the playing card 100 has four icons 113 on the first face 101 and four icons 213 (FIG. 2) on the second face 201, the playing card 100 is capable of having up to eight different orientations and is capable of indicating up to ten different periods of time based on the orientation and the order by which the orientations change.

The tracking of time is usable, for example, for the user to strategically put a playing card 100 into play, knowing that the effect or action of the playing card 100 will occur having certain values after a given quantity of turns, so that the user is able to attempt to time dealing damage or some other effect, on the third turn after playing the example playing card 100 in flowchart 300. In some embodiments, a playing card 100 that has an action area 111 configured to instruct that a weapon is to be used may include a series of icons 113 that instruct a user to rotate the playing card 100 through a predetermined quantity of turns to simulate readying the weapon, loading the weapon, aiming the weapon and firing the weapon. In some embodiments, a playing card 100 includes one or more icons 113 that instruct a user to move the playing card 100 to one or more orientations throughout the course of the game with which the playing card 100 is associated and to stop moving the playing card 100 to a different orientation after a predetermined quantity of movements upon which the action or effect of the playing card 100 is held in abeyance until an event or action occurs in the context of the game with which the playing card 100 is associated. For example, if an action area 111 is configured to instruct that a grenade is to be used may include one or more icons 113 that instruct a user to move the playing card 100 through a predetermined quantity of turns to simulate readying the grenade, then after reaching the predetermined quantity of turns, the playing card 100 sits without expiring in the context of the game until an event in the context of the game occurs. Such an event, for example, is the playing of another card, the user hitting a trigger, the user announcing that the grenade has gone off, an event in which the user's character or a different user's character reaches a particular location in the context of the game, an event in which the user's character or a different user's character reaches a particular location in the context of the game, moves a predetermined quantity of paces in the context of the game, or some other suitable event associated with the action or effect of the playing card 100.

Similarly, the tracking of time makes it possible to identify a duration of an effect or an action of the playing card 100. For example, based on the rotation or movement from one orientation to another, a user is able to track when the playing card 100 and the effect or action thereof will expire. Additionally, if a playing card 100 has icons such as those shown in flowchart 300, wherein the icons 113 have different values for a particular action or effect, the value of the action or effect changes between there not being an action or effect in a particular turn to some other value over time. This results in a fluctuating value for an action or effect over the turns in which the playing card 100 is in play as the playing card 100 is moved between different orientations that cause icons 113 having different values to be in the active position.

In some embodiments, values are positive or negative, and associated with one or more of strength, power, wealth, health, magic, magic power, magic range, weaponry power, weaponry range, movement, character speed, character flight, vehicle speed, vehicle flight, animal speed (e.g., horse or some other real or imaginary animal capable of carrying the character in the context of the game with or without magic), animal flight (e.g., dragon or some other real or imaginary suitable animal capable of flight with or without magic) level, character size, weapon size, weapon strength, weapon type, defensive capability, shield size, shield strength, cloning capability, join forces capability, invincibility, a time in jail, a time until health is strong enough or the character is safe to proceed in the context of the game, or some other suitable metric having an effect in the context of the game or an effect on an action in the context of the game.

In some embodiments, the playing card 100 has different combinations of quantities and/or types of icons 113/213 on one or more of the first face 101 and the second face 201 of the playing card 100. In some embodiments, a quantity of icons 113 on the first face 101 is equal to a quantity of icons 213 on the second face 201. In some embodiments, a quantity of icons 113 on the first face 101 is different from a quantity of icons 213 on the second face 201. In some embodiments, the first face 101 has one or more icons 113 configured to instruct the user to rotate the playing card 100, one or more icons 113 configured to instruct the user to flip the playing card 100, one or more icons 113 configured to instruct the user to return the playing card 100 to an orientation out of order from a direct rotation, one or more icons 113 configured to instruct the user to tap the playing card 100, one or more icons 113 configured to instruct the user to tip the playing card 100, one or more icons 113 configured to instruct the user to cause a different playing card to be affected, one or more icons 113 configured to instruct the user to affect the playing card 100 (such as move, rotate, orient, expire, or some other suitable action) based on an effect or orientation of a different playing card, one or more icons 113 configured to instruct some other suitable manipulation or movement of the playing card 100, an area of the playing card moved to the active position that lacks an icon 113, or a combination thereof. If the second face 201 of the playing card 100 includes icons 213, one of more of the icons 213 are configured to have similar configurations to those discussed with respect to icons 113. In some embodiments, icons 213 are different form icons 113.

In some embodiments, the orientation of the playing card 100 has an effect on the action or effect of the playing card 100 in the context of the game. In some embodiments, the action area 111 is configured to instruct the user to cause the effect or action indicated in the action area 111, the action area 111 optionally includes instructions to temper, strengthen, or direct the action or effect based on the orientation of the playing card 100 in the given turn.

In some embodiments, the action area 111 is configured to instruct the user to increase or decrease the value of the icon 113 in the active position by a predetermined amount if the playing card is in an upright position, some event in the context of the game is in occurrence, or a combination thereof.

In some embodiments, the action area 111 is configured to instruct the user to decrease or increase the value of the icon 113 in the active position by a predetermined amount if the playing card 100 is in a horizontal position, some other event in the context of the game is in occurrence, or a combination thereof.

In some embodiments, the increase or decrease in the value of the icon 113 in the active position when the playing card 100 is in the upright position is the same as the increase or decrease of the value of the icon 113 in the active position when the playing card 100 is in the horizontal position.

In some embodiments, the increase or decrease in the value of the icon 113 in the active position when the playing card 100 is in the upright position is different from the increase or decrease of the value of the icon 113 in the active position when the playing card 100 is in the horizontal position.

In some embodiments, the increase or decrease in the value of the icon 113 in the active position when the playing card 100 is in the upright position is based on an event in the context of the game that is the same as the event in the context of the game upon which the increase or decrease of the value of the icon 113 in the active position when the playing card 100 is in the horizontal position is based.

In some embodiments, the increase or decrease in the value of the icon 113 in the active position when the playing card 100 is in the upright position is based on an event in the context of the game that is the different from the event in the context of the game upon which the increase or decrease of the value of the icon 113 in the active position when the playing card 100 is in the horizontal position is based.

In some embodiments, the playing card 100 is configured to instruct the user to skip a turn, to move the playing card 100 to a different orientation, to skip moving the playing card 100 to a different orientation, to take two turns, to fast forward or rewind the playing card 100 to a different orientation or some other suitable action or inaction based on one or more of a different playing card being put into play, some other occurrence in the context of the game, the orientation of the playing card 100 at the time the different playing card is put into play, the orientation of the playing card 100 and the different playing card at the time the different playing card is put into play, the orientation of the playing card 100 and the different playing card at a time after the different playing card is put into play, some other suitable occurrence in the context of the game, or a combination thereof.

In some embodiments, one or more of the icons 113 or the action area 111 is configured to instruct the user to freeze the playing card 100 in one orientation upon being put into play or upon reaching one of the orientations for a predetermined quantity of turns, indefinitely, until some other playing card is put into play, or until an event in the context of the game occurs. In some embodiments, one or more of the icons 113 or the action area 111 is configured to instruct the user to freeze the playing card 100 in one orientation for a predetermined quantity of turns, indefinitely, until another playing card is put into play, or until an event in the context of the game occurs based on an event occurring in the context of the game. For example, if a user puts a playing card 100 into play that instructs the user to inflict high amounts of damage on his adversary, and the user's character has a brother that dies in the context of the game, the playing card 100 is configured to instruct the user to freeze the playing card 100 for a period of time associated with grieving, or until one or more other playing cards associated with the game are in a particular orientation (i.e., the stars align), and the character's brother is resurrected. In some embodiments, the freezing or unfreezing of the playing card 100 is based on one different playing card being put into play, and the playing card 100 being frozen until the different playing card expires in the context of the game, is doubled-up (e.g., two of the same cards are drawn), or a more powerful card (e.g., a trump card) is put into play by the user or another user.

In some embodiments, the orientation of the playing card 100 is not limited to an upright or a horizontal position. In some embodiments, the orientation is based on which of the first face 101 or the second face 201 of the playing card 100 is viewable and/or how many potential orientations the playing card 100 has. For example, if the playing card 100 is an eight-sided card, the icon 113 in the active position could be at the top-side, bottom-side, left-side, right-side, or some location there between.

In some embodiments, given the potentially numerous quantities of sides, locations, corners, faces, orientations, effects dependent on one or more other playing cards, and combinations thereof, the playing card 100 is capable of having more than one type of effect or action beyond just one action going into effect or a value tied thereto. In some embodiments, one or more icons 113 on the first face 101 or one or more icons 213 the second face 201 of the playing card 100 and/or one or more instructions in the action area 111 are configured to instruct a user to cause an effect in the context of the game that is different from at least one other effect instructed by an icon 113 on the first face 101, an icon 213 on the second face 201, an instruction in the action area 111 on the first face 101, an instruction in the action area 211 (FIG. 2) on the second face 201, or some other suitable portion of the playing card 100 or rule associated with the game that would otherwise result in the playing card 100 having only one effect.

In some embodiments, the action area 111 on the first face 101 instructs the user to cause a different effect or action in the context of the game compared to the action area 211 on the second face 201. Thus, if the user is instructed by one or more icons 113 on the first face 101 of the playing card 100, or the user is otherwise caused by some other occurrence in the game to flip the playing card 100, then the action or effect on the second face 201 of the playing card 100 may go into effect if the playing card 100 is flipped and an icon 213 or other type of instruction instructs the user to cause the effect or action on the second face 201 to occur.

In some embodiments, the playing card 100 is configured to have a plurality of different actions or effects in the context of the game based on the instructions in the action area 111 of one or more of the first face 101, the optional action area 211 of the second face 201, the icons 113/213 on the first face 101 or the second face 201, the potential orientations of the playing card 100, the potential orientations of other playing cards, events in the context of the game, or combinations thereof.

Tracking passage of time, tracking a player turn, tracking a duration of an effect or action, determining a valuation or strength of an effect or action, or determining a type of effect or action based on the orientation of the playing card 100 makes it possible to perform such functions in the context of the game free from relying on dice, chips, tokens, or some other form of counter. In some embodiments, however, one or more of the icons 113/213 or action areas 111/211 is configured to instruct the user to cause an effect or action in the context of the game based on a value determined from dice, chips, tokens, or some other form of counter associated with the game.

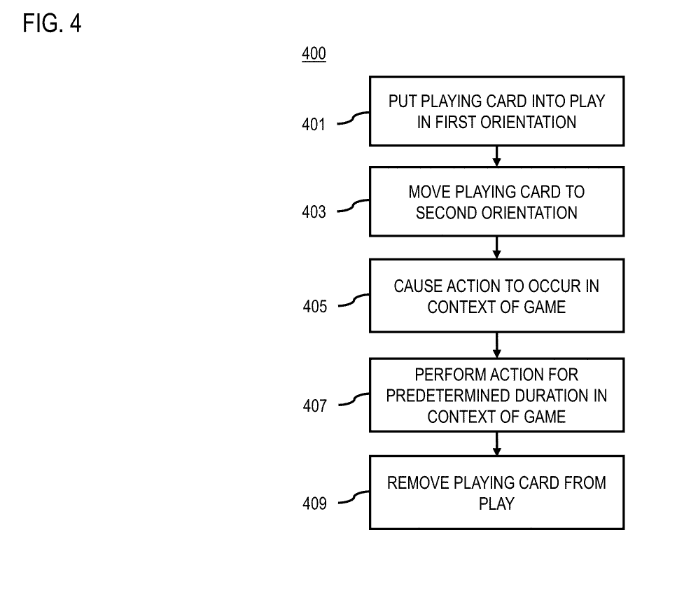

FIG. 4 is a flowchart of a method 400 of using a playing card such as playing card 100 (FIG. 1) in the context of a game with which the playing card is associated.

In step 401, a playing card is put into play. In some embodiments, the playing card is put into play by placing or causing the playing card to be displayed in a game play area. In some embodiments a user causes the playing card to be put into play. In some embodiments a processor such as that included in processor-based system 500 (FIG. 5) causes the playing card to be put into play, causes the playing card to be viewable by a display, or facilitates interaction and/or viewing of the playing card by way of a user interface.

In some embodiments, the game play area is a table, a chair, a floor, a display, a user interface, or some other suitable area in which one or more users are capable of interacting with and/or viewing the playing card. The playing card has a first face, a second face opposite the first face, and at least three sides. The first face has at least one icon configured to instruct a user to move the playing card to one of at least three orientations. The playing card is put into play in a first orientation of the at least three orientations.

In step 403, the playing card is moved to a second orientation of the at least three orientations based on the at least one icon. Each orientation of the at least three orientations has an effect in the context of a game with which the playing card is associated.

In some embodiments, moving the playing card comprises rotating the playing card from the first orientation to the second orientation based on a time in the context of the game. A time in the context of the game, for example, is a player turn. In some embodiments, if the playing card has a quantity of icons, the playing card is configured to be in play for a quantity of turns equal to the quantity of icons. In some embodiments, the playing card is active for each of the quantity of turns. In some embodiments, though in play, the playing card is active for a quantity of turns that is lesser than a quantity of icons. A quantity of turns for which the playing card is active is based, at least in part, on the icons.

In some embodiments, rotating the playing card comprises rotating the playing card in a counter-clockwise direction from the first orientation to the second orientation based on the at least one icon. In some embodiments, rotating the playing card comprises rotating the playing card in a clockwise direction from the first orientation to the second orientation based on the at least one icon.

In some embodiments, the first face has at least two icons. A first icon of the at least two icons is in a first position if the playing card is in the first orientation. Moving the playing card from the first orientation to the second orientation causes a second icon of the at least two icons to be in the first position if the playing card is in the second orientation.

In some embodiments, first face of the playing card is viewable if the playing card is in the first orientation, and the second face of the playing card is hidden from view if the playing card is in the first orientation, and moving the playing card from the first orientation to the second orientation causes the second face of the playing card to be viewable.

In some embodiments, moving the playing card to cause the second face to be viewable comprises flipping the playing card such that the first face is hidden from view if the playing card is in the second orientation. In some embodiments, moving the playing card comprises rotating the playing card from the first orientation to the second orientation based on an event in the context of the game.

In step 405, an action is caused to occur in the context of the game based on the at least one icon.

In step 407, the action is performed for a predetermined duration in the context of the game based on the at least one icon, or one or more other icons based on a movement of the one or more other icons to the active position upon moving the playing card to one of the at least three orientations.

In step 409, the playing card is removed from play. If the playing card is expired based on a quantity of turns, then the playing card is inactivated. If the playing card is removed from play for a reason other than expiration, then the playing card is optionally put back into play in one of the at least three orientations based on one or more of an instruction or icon on the first face, an instruction or icon on the second face, an orientation of the at least three orientations at a time of removal of the playing card from play in the context of the game, the default orientation or some other predetermined orientation.

FIG. 5 is a functional block diagram of a computer or processor-based system 500 upon which or by which an embodiment is implemented.

Processor-based system 500 is programmed to cause a playing card such as playing card 100 (FIG. 1) to be displayed as described herein, and includes, for example, bus 501, processor 503, and memory 505 components.

In some embodiments, the processor-based system is implemented as a single “system on a chip.” Processor-based system 500, or a portion thereof, constitutes a mechanism for performing one or more steps of causing a playing card to be displayed.

In some embodiments, the processor-based system 500 includes a communication mechanism such as bus 501 for transferring information and/or instructions among the components of the processor-based system 500. Processor 503 is connected to the bus 501 to obtain instructions for execution and process information stored in, for example, the memory 505. In some embodiments, the processor 1003 is also accompanied with one or more specialized components to perform certain processing functions and tasks such as one or more digital signal processors (DSP), or one or more application-specific integrated circuits (ASIC). A DSP typically is configured to process real-world signals (e.g., sound) in real time independently of the processor 503. Similarly, an ASIC is configurable to perform specialized functions not easily performed by a more general purpose processor. Other specialized components to aid in performing the functions described herein optionally include one or more field programmable gate arrays (FPGA), one or more controllers, or one or more other special-purpose computer chips.

In one or more embodiments, the processor (or multiple processors) 503 performs a set of operations on information as specified by a set of instructions stored in memory 505 related to causing a playing card to be displayed. The execution of the instructions causes the processor to perform specified functions.

The processor 503 and accompanying components are connected to the memory 505 via the bus 501. The memory 505 includes one or more of dynamic memory (e.g., RAM, magnetic disk, writable optical disk, etc.) and static memory (e.g., ROM, CD-ROM, etc.) for storing executable instructions that when executed perform the steps described herein to cause a playing card to be displayed. The memory 505 also stores the data associated with or generated by the execution of the steps.

In one or more embodiments, the memory 505, such as a random access memory (RAM) or any other dynamic storage device, stores information including processor instructions for causing a playing card to be displayed. Dynamic memory allows information stored therein to be changed by system 500. RAM allows a unit of information stored at a location called a memory address to be stored and retrieved independently of information at neighboring addresses. The memory 505 is also used by the processor 503 to store temporary values during execution of processor instructions. In various embodiments, the memory 505 is a read only memory (ROM) or any other static storage device coupled to the bus 501 for storing static information, including instructions, that is not changed by the system 500. Some memory is composed of volatile storage that loses the information stored thereon when power is lost. In some embodiments, the memory 505 is a non-volatile (persistent) storage device, such as a magnetic disk, optical disk or flash card, for storing information, including instructions, that persists even when the system 500 is turned off or otherwise loses power.

The term “computer-readable medium” as used herein refers to any medium that participates in providing information to processor 503, including instructions for execution. Such a medium takes many forms, including, but not limited to computer-readable storage medium (e.g., non-volatile media, volatile media). Non-volatile media includes, for example, optical or magnetic disks. Volatile media include, for example, dynamic memory. Common forms of computer-readable media include, for example, a floppy disk, a flexible disk, a hard disk, a magnetic tape, another magnetic medium, a CD-ROM, CDRW, DVD, another optical medium, punch cards, paper tape, optical mark sheets, another physical medium with patterns of holes or other optically recognizable indicia, a RAM, a PROM, an EPROM, a FLASH-EPROM, an EEPROM, a flash memory, another memory chip or cartridge, or another medium from which a computer can read. The term computer-readable storage medium is used herein to refer to a computer-readable medium.

An aspect of this description is related to a playing card. The playing card comprises a substrate having a first face, a second face opposite the first face, and at least three sides. The first face has at least one icon configured to instruct a user to move the substrate to one of at least three orientations. Each orientation of the at least three orientations has an effect in the context of a game with which the playing card is associated.

Another aspect of this description is related to a method. The method comprises putting a playing card into play. The playing card has a first face, a second face opposite the first face, and at least three sides. The first face has at least one icon configured to instruct a user to move the playing card to one of at least three orientations. The playing card is put into play in a first orientation of the at least three orientations. The method also comprises moving the playing card to a second orientation of the at least three orientations based on the at least one icon. Each orientation of the at least three orientations has an effect in the context of a game with which the playing card is associated.

A further aspect of this description is related to an apparatus comprising a processor and a memory. The memory has a set of instructions that, when executed by a processor, cause the apparatus to cause a playing card to be viewable by way of a display. The playing card comprises a first face, a second face opposite the first face, and at least three sides. At least one of the first face or the second face is caused to be viewable by way of the display at a moment in time. The first face has at least one icon configured to instruct a user to move the playing card to one of at least three orientations. Each orientation of the at least three orientations has an effect in the context of a game with which the playing card is associated.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A playing card, comprising:
a substrate having a first face, a second face opposite the first face, and at least three sides,
wherein
the first face has at least one icon configured to instruct a user to move the substrate to one of at least three orientations, and
each orientation of the at least three orientations has an effect in the context of a game with which the playing card is associated.

2. The playing card of claim 1, wherein a quantity of icons is equal to a quantity of sides of the substrate.

3. The playing card of claim 1, wherein
the at least one icon is a first icon, and
the second face has at least one second icon configured instruct the user to move the substrate to one of the at least three orientations.

4. The playing card of claim 1, wherein
the at least one icon is configured to instruct the user to rotate the substrate from a first orientation of the at least three orientations to a second orientation of the at least three orientations based on a time in the context of the game.

5. The playing card of claim 1, wherein
the at least one icon is a first icon, and
the first face has a second icon located on the first face such that the movement of the substrate to one of the at least three orientations causes the second icon to be directed toward a target in the context of the game, the target being independent of the substrate.

6. The playing card of claim 1, wherein
the first face has at least three corner regions and at least three icons,
each icon of the at least three icons is in one of the at least three corner regions,
a first icon of the at least three icons is configured to instruct the user to rotate the substrate from a first orientation of the at least three orientations to a second orientation of the at least three orientations based on a time in the context of the game,
the first icon is in a first position if the substrate is in the first orientation, and
a second icon of the at least three icons is located on the first face such that the second icon is in the first position if the substrate is in the second orientation.

7. The playing card of claim 6, wherein a third icon of the at least three icons is configured to instruct the user to flip the substrate to a third orientation of the at least three orientations.

8. The playing card of claim 1, wherein
the first face has at least three corner regions and at least three icons,
each icon of the at least three icons is in one of the at least three corners,
a first icon of the at least three icons is configured to instruct the user to move the substrate from a first orientation of the at least three orientations to a second orientation of the at least three orientations based on an event in the context of the game,
the first icon is in a first position if the substrate is in the first orientation, and
a second icon of the at least three icons is located on the first face such that the second icon is in the first position if the substrate is in the second orientation.

9. The playing card of claim 1, wherein the at least one icon is further configured to cause an action to occur in the context of the game.

10. The playing card of claim 9, wherein the at least one icon is further configured to instruct the user regarding a duration of the action in the context of the game.

11. A method, comprising:
putting a playing card into play, the playing card having a first face, a second face opposite the first face, and at least three sides, the first face having at least one icon configured to instruct a user to move the playing card to one of at least three orientations, the playing card being put into play in a first orientation of the at least three orientations; and
moving the playing card to a second orientation of the at least three orientations based on the at least one icon,
wherein each orientation of the at least three orientations has an effect in the context of a game with which the playing card is associated.

12. The method of claim 11, wherein moving the playing card comprises rotating the playing card from the first orientation to the second orientation based on a time in the context of the game.

13. The method of claim 11, wherein the first face has at least two icons, a first icon of the at least two icons is in a first position if the playing card is in the first orientation, and moving the playing card from the first orientation to the second orientation causes a second icon of the at least two icons to be in the first position if the playing card is in the second orientation.

14. The method of claim 11, wherein the first face of the playing card is viewable if the playing card is in the first orientation, the second face of the playing card is hidden from view if the playing card is in the first orientation, and moving the playing card from the first orientation to the second orientation causes the second face of the playing card to be viewable.

15. The method of claim 14, wherein moving the playing card to cause the second face to be viewable comprises flipping the playing card such that the first face is hidden from view if the playing card is in the second orientation.

16. The method of claim 11, moving the playing card comprises rotating the playing card from the first orientation to the second orientation based on an event in the context of the game.

17. The method of claim 11, further comprising:
causing an action to occur in the context of the game based on the at least one icon.

18. The method of claim 11, further comprising:
performing the action for a predetermined duration in the context of the game based on the at least one icon.

19. The method of claim 11, further comprising:
removing the playing card from play; and
putting the playing card back into play in one of the at least three orientations based on one or more of an instruction on the first face, an instruction on the second face, an orientation of the at least three orientations at a time of removal of the playing card from play in the context of the game, or the at least one icon.

20. An apparatus, comprising:
a processor; and
a memory having a set of instructions that, when executed by a processor, cause the apparatus to:
cause a playing card to be viewable by way of a display, the playing card comprising a first face, a second face opposite the first face, and at least three sides,
wherein
at least one of the first face or the second face is caused to be viewable by way of the display at a moment in time,
the first face has at least one icon configured to instruct a user to move the playing card to one of at least three orientations, and
each orientation of the at least three orientations has an effect in the context of a game with which the playing card is associated.
